(19) United States
(12) Patent Application Publication
(10) Pub. No.: US 2020/0089421 A1
(43) Pub. Date: Mar. 19, 2020

(54) DATA STORAGE DEVICE, OPERATION METHOD THEREOF, AND STORAGE SYSTEM INCLUDING THE SAME

(71) Applicant: SK hynix Inc., Gyeonggi-do (KR)

(72) Inventor: Yong Seok OH, Gyeonggi-do (KR)

(21) Appl. No.: 16/385,644

(22) Filed: Apr. 16, 2019

(30) Foreign Application Priority Data
Sep. 18, 2018 (KR) 10-2018-0111388

(51) Int. Cl. G06F 3/06; G06F 12/02

(52) U.S. Cl. CPC G06F 3/0643; G06F 3/0611; G06F 3/0625; G06F 12/0246; G06F 3/0667; G06F 3/0679; G06F 3/0665

(57) ABSTRACT

A data storage device includes a storage, and a controller configured to control data exchange with the storage in response to a request of a host device; generate a name space, which is a logical area and includes one or more sub-spaces each serving as a physical area of the storage, in response to the request of the host device; and manage mapping information between the name space and the sub-spaces, wherein each sub-space constituting the name space is selected to have a physically continuous or discontinuous address.

### CROSS-REFERENCES TO RELATED APPLICATION

The present application claims priority under 35 U.S.C. § 119(a) to Korean application number 10-2018-0111388, filed on Sep. 18, 2018, which is incorporated herein by reference in its entirety.

### BACKGROUND

### 1. Technical Field

Various embodiments generally relate to a semiconductor integrated apparatus, and, more particularly, to a data storage device, an operation method thereof, and a storage system including the same.

### 2. Related Art

There are continuously increasing demands for a flash memory due to its advantage of a large capacity, nonvolatility, low cost, low power consumption, a high speed data processing speed and the like.

A storage medium using the flash memory may be implemented in a solid state drive (SSD) type substituting for a hard disk, an embedded type available as an embedded memory, a mobile type and the like, and is applied to various electronic appliances such as an electronic appliance for mainly performing multimedia data processing, a navigation system for a vehicle, and a black box.

Recently, for efficient data management and process of a large capacity storage device, there has been much research into a storage device that has a partition or name space function capable of providing a plurality of logical storage areas or spaces to one physical device.

### SUMMARY

In an embodiment, a data storage device may include: a to storage; and a controller configured to: control data exchange with the storage in response to a request of a host device; generate a name space, which is a logical area and includes one or more sub-spaces each serving as a physical area of the storage, in response to the request of the host device; and manage mapping information between the name space and the sub-spaces, wherein each sub-space constituting the name space is selected to have a physically continuous or discontinuous address.

In an embodiment, an operation method of a data storage device is an operation method of a data storage device including a storage and a controller configured to control data exchange with the storage and may include the steps of: generating, by the controller, a name space, which is a logical area and includes one or more sub-spaces each serving as a physical area of the storage, in response to a request of the host device; and updating, by the controller, mapping information between the name space and the sub-spaces, wherein each sub-space constituting the name space is selected to have a physically continuous or discontinuous address.

In an embodiment, a storage system may include: a host device; and a data storage device including a storage and a controller configured to control data exchange with the storage according to a request of the host device, wherein the controller further: generates a name space, which is a logical area and includes one or more sub-spaces serving as a physical area of the storage, in response to the request of the host device; and manages mapping information to between the name space and the sub-spaces, and wherein each sub-space constituting the name space is selected to have a physically continuous or discontinuous address.

In an embodiment, a memory system may include: a memory device including a plurality of storage segments each represented by a physical address; and a controller configured to: assign one or more among the storage segments for a name space addressable by an external device; release one or more among the storage segments assigned for the name space; update relationship between one or more among the assigned and released storage segments and the name space within first and second tables; and control, through the first and second tables, access to the assigned storage segments in response to an access request provided along with a logical address of the name space from the external device.

### BRIEF DESCRIPTION OF THE DRAWINGS

FIG. 1 is a block diagram of a data storage device in accordance with an embodiment.

FIG. 2 is a block diagram of a controller in accordance with an embodiment.

FIG. 3 is a diagram of a name space manager in accordance with an embodiment.

FIG. 4 to FIG. 6 are diagrams illustrating name space management tables in accordance with an embodiment.

FIG. 7 is a diagram for explaining a name space management concept in accordance with an embodiment.

FIG. 8 is a diagram for explaining a name space mapping concept in accordance with an embodiment.

FIG. 9 is a diagram for explaining a name space search concept in accordance with an embodiment.

FIG. 10 is a flowchart for explaining a name space generation method in accordance with an embodiment.

FIG. 11 and FIG. 12 are conceptual diagrams for explaining a name space generation operation in accordance with an embodiment.

FIG. 13 is a flowchart for explaining a name space deletion method in accordance with an embodiment.

FIG. 14 is a conceptual diagram for explaining a name space deletion operation in accordance with an embodiment.

FIG. 15 and FIG. 16 are flowcharts for explaining a name space change method in accordance with an embodiment.

FIG. 17 is a diagram illustrating a data storage system in accordance with an embodiment.

FIG. 18 and FIG. 19 are diagrams illustrating a data processing system in accordance with an embodiment.

FIG. 20 is a diagram illustrating a network system including a data storage device in accordance with an embodiment.

FIG. 21 is a block diagram illustrating a nonvolatile memory device included in a data storage device in accordance with an embodiment.

### DETAILED DESCRIPTION

Hereinafter, a data storage device, an operation method thereof, and a storage system including the same will be described below with reference to the accompanying drawings through various examples of embodiments.

FIG. 1 is a configuration diagram of a data storage device 10 in accordance with an embodiment.

Referring to FIG. 1, the data storage device 10 may include a controller 110 and a storage 120.

The controller 110 may control the storage 120 in response to a request of a host device. For example, the controller 110 may allow data to be programmed in the storage 120 according to a program (write) request of the host device. Furthermore, the controller 110 may provide the data written in the storage 120 to the host device in response to a read request of the host device.

The storage 120 may write data or output the written data under the control of the controller 110. The storage 120 may include a volatile or nonvolatile memory apparatus. In an embodiment, the storage 120 may be implemented using a memory device selected from various nonvolatile memory devices such as an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-MRAM). The storage 120 may include a plurality of dies Die 0 to Die n, a plurality of chips, or a plurality of packages. In addition, the storage 120 may include a single-level cell that stores one-bit data in one memory cell or a multi-level cell that stores multi-bit data in one memory cell.

In an embodiment, the controller 110 may include a name space manager 20 configured to manage one or more name spaces.

A name space is a logical storage section addressable by a host device. A single name space is mapped to one or more sub-spaces. A sub-space is a physical storage section addressable by the data storage device 10. Physical storage space of the storage 10 is divided into a plurality of the sub-spaces, and one or more among the sub-spaces are grouped to be assigned and mapped to a single name space. The host device can recognize the storage 10 through one or more name spaces each mapped to one or more sub-spaces.

In order to facilitate the understanding of the name space manager 20 to be described below, terms to be described in the present technology are defined as follows.

| | |
|---|---|
| NTHT | Entry table having information of sizes of name |
| | spaces and mapping table ID |
| NTBT | Mapping table having information of logical and |
| | physical address offsets and sizes of sub-spaces, |
| | and following mapping table ID for each mapping |
| | table ID assigned to each sub-space |
| NTBC | Index cache as optimized mapping table in order to |
| | easily access corresponding mapping table |
| NS_ID | Name space ID |
| NS_SIZE | Name space size |
| START_TBID | Starting mapping table ID to be initially referred to |
| | in order to access sub-space corresponding to name |
| | space |
| TBID | Mapping table ID assigned to each sub-space |
| NS_L_OFFSET | Logical address offset of corresponding sub-space |
| NS_P_OFFSET | Physical address offset of corresponding sub-space |
| TB_SIZE | Sub-space size |
| NEXT_TBID | Mapping table ID following corresponding mapping |
| | table |

A plurality of name spaces representing storage spaces of the storage 120 may have substantially the same capacity or different capacities or may have substantially the same protection type or different protection types. In an embodiment, the capacity and the protection type of the name space may be designated by the host device.

The name space manager 20 may be configured to generate, delete, or change the name space according to a request of the host device.

In an embodiment, when the host device requests the generation of a name space, the name space manager 20 checks whether a free area with a size requested by the host device exists in the storage 120, and may allocate the free area with the size requested by the host device for the name space area when the free area exists. When the name space is generated, the name space manager 20 may map logical and physical addresses of the name space in the entry table NTHT, the mapping table NTBT and the index cache NTBC.

Since one name space may include at least one sub-space, the name space manager 20 may assign a mapping table ID to each sub-space included in each name space, thereby generating a mapping table NTBT.

Each name space may have logically continuous addresses. When one name space includes a plurality of sub-spaces, the sub-spaces may have physically discontinuous addresses and thus the name space manager 20 may include, as link information, the following mapping table ID NEXT_TBID of the mapping table ID TBID as a current entry in the mapping table NTBT.

In an embodiment, in response to a name space generation request of the host device, when a free area with a requested size or more exists in the storage 120, the name space manager 20 may select at least one sub-space having physically continuous or discontinuous addresses, allocate the selected sub-space to the name space, and update address mapping information in the entry table NTHT, the mapping table NTBT and the index cache NTBC.

In another aspect, in response to the name space generation request of the host device, the name space manager 20 may generate a name space by combining sub-spaces having physically discontinuous addresses and the requested size.

In an embodiment, in response to a name space deletion request of the host device, the name space manager 20 may free one or more sub-spaces included in the delete-requested name space, and update the address mapping information in the entry table NTHT, the mapping table NTBT and the index cache NTBC.

In an embodiment, in response to a name space size increase request of the host device, when there is a free area with the requested size or more, the name space manager 20 may select at least one physically continuous or discontinuous sub-space, additionally allocate the selected sub-space to the requested name space, and update the address mapping information in the entry table NTHT, the mapping table NTBT and the index cache NTBC.

In an embodiment, in response to a name space size decrease request of the host device, the name space manager 20 may free one or more sub-spaces having the requested size within the requested name space, and update the address mapping information in the entry table NTHT, the mapping table NTBT and the index cache NTBC.

The name space manager 20 may substantially manage name space meta information in the entry table NTHT for each name space to access the mapping table NTBT through the entry table NTHT. The mapping table NTBT may have information of logical and physical address offsets and sizes of the sub-spaces allocated for the name spaces.

In order to quickly respond to a name space access request of the host device, the name space manager 20 may generate the index cache NTBC so as to quickly search the mapping table NTBT.

As described above, the name space manager 20 in accordance with an embodiment may combine sub-spaces having physically discontinuous addresses to configure name spaces.

Since the name space have different size and the sub-spaces included in respective name spaces are physically discontinuous, when the generation and deletion of name spaces in the storage 120 are repeated, the storage space of the storage 120 may be fragmented.

The total capacity of fragmented physical areas of the storage 120 may be meaningful for the generation of the name space. Accordingly, the fragmented physical areas may be defined as the sub-spaces, and the sub-spaces may be combined with one another to generate a name space with a size requested by the host device. The sub-spaces may be physically discontinuous within the storage 120, but logical addresses within the corresponding name spaces may be recognized as logically continuous by the host device while individual name space being used as a logically independent area. Furthermore, the data storage device 10 may not waste the fragmented physical areas so that it is possible to improve the utilization efficiency of a physical storage area within the storage 120.

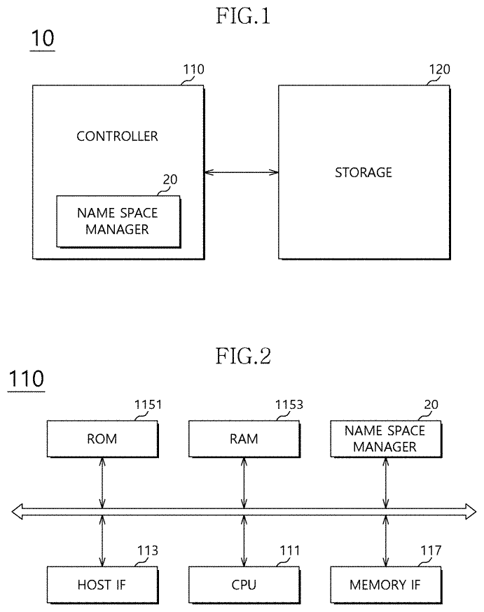

FIG. 2 is a configuration diagram of the controller 110.

Referring to FIG. 2, the controller 110 may include a central processing unit (CPU) 111, a host interface (IF) 113, a ROM 1151, a RAM 1153, a memory interface (IF) 117, and the name space manager 20.

The central processing unit (CPU) 111 may be configured to transfer various types of control information required for a data read or write operation for the storage 120 to the host interface (IF) 113, the RAM 1153, and the memory interface (IF) 117. In an embodiment, the central processing unit (CPU) 111 may operate according to firmware provided for various operations of the data storage device 10. In an embodiment, the central processing unit (CPU) 111 may perform a function of a flash translation layer (FTL) for performing garbage collection, address mapping, wear leveling and the like for substantially managing the storage 120, a function of detecting and correcting an error of data read from the storage 120, and the like.

The host interface (IF) 113 may provide a communication channel for receiving a command and a clock signal from the host device and controlling data input/output under the control of the central processing unit (CPU) 111. Particularly, the host interface (IF) 113 may provide a physical connection between the host device (not shown) and the data storage device 10. The host interface (IF) 113 may provide interfacing with the data storage device 10 in correspondence with a bus format of the host device. The bus format of the host device may include at least one of standard interface protocols such as a secure digital, a universal serial bus (USB), a multi-media card (MMC), an embedded MMC (eMMC), a personal computer memory card international association (PCMCIA), a parallel advanced technology attachment (PATA), a serial advanced technology attachment (SATA), a small computer system interface (SCSI), a serial attached SCSI (SAS), a peripheral component interconnection (PCI), a PCI express (PCI-e or PCIe), and a universal flash storage (UFS).

The ROM 1151 may store program codes required for an operation of the controller 110, for example, firmware or software, and store code data and the like used by the program codes.

The RAM 1153 may store data required for the operation of the controller 110 or data generated by the controller 110.

In a booting operation, the central processing unit (CPU) 111 may load a boot code stored in the storage 120 or the ROM 1151 to the RAM 1153, thereby controlling the booting operation of the data storage device 10.

The memory interface 117 may provide a communication channel for signal transmission/reception between the controller 110 and the storage 120. The memory interface 117 may write data, which has been temporarily stored in a buffer memory, in the storage 120 under the control of the central processing unit (CPU) 111. Furthermore, the memory interface 117 may transfer data read from the storage 120 to the buffer memory for temporary storage.

In response to requests of the host device, the name space manager 20 may generate a name space through a combination of at least one sub-space, delete the name space by allocating at least one sub-space included in the name space to a free area, resize the name space by adding at least one sub-space to the name space, or resize the name space by allocating at least one of a plurality of sub-spaces constituting the name space to a free area.

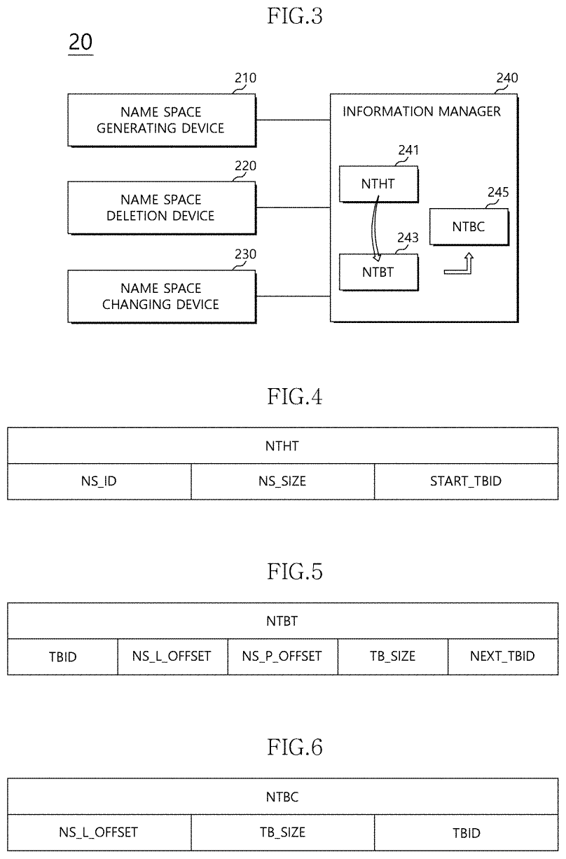

The name space manager 20, for example, may be configured as illustrated in FIG. 3; however, an embodiment is not limited thereto.

FIG. 3 is a configuration diagram of the name space manager 20 in accordance with an embodiment, and FIG. 4 to FIG. 6 are configuration diagrams of name space management tables in accordance with an embodiment.

Referring to FIG. 3, the name space manager 20 in accordance with an embodiment may include a name space generating device 210, a name space deletion device 220, a name space changing device 230, and an information manager 240.

The information manager 240 may include the entry table NTHT 241, the mapping table NTBT 243, and the index cache NTBC 245.

The entry table NTHT 241, for example, may be configured as illustrated in FIG. 4. In an embodiment, the entry table NTHT 241 may have information of the name space size NS_SIZE and the starting mapping table ID START_TBID for each according to name space ID NS_ID.

The mapping table ID TBID may be assigned to each sub-space.

Referring to FIG, 5, the mapping table NTBT 243 may have information of the logical address offset NS_L_OFFSET, the physical address offset NS_P_OFFSET, the sub-space size TB_SIZE, and the following mapping table ID NEXT_TBID for each mapping table ID TBID.

By such a data structure, the name space manager 20 may access the mapping table NTBT through the entry table NTHT. Then, the name space manager 20 may access the storage area of the storage 120 through the accessed mapping table NTBT.

Since the data storage device 10 performs data input/output according to a request of the host device, the mapping table NTBT may be reconfigured on the basis of information, for example, a logical address provided from the host device.

Referring to FIG. 6, the index cache NTBC may have information of the sub-space size TB_SIZE and the mapping table ID TBID of a sub-space represented by the logical address offset NS_L_OFFSET. In addition, the index cache NTBC may be constructed for each name space.

When a command (a read or a write), a name space ID NS_ID, and a logical address are transmitted from the host device, the name space manager 20 may access the index cache NTBC 245 corresponding to the provided name space ID NS_ID to find the mapping table ID TBID, and thus access the mapping table NTBT 243 to find a physical address corresponding to the provided logical address.

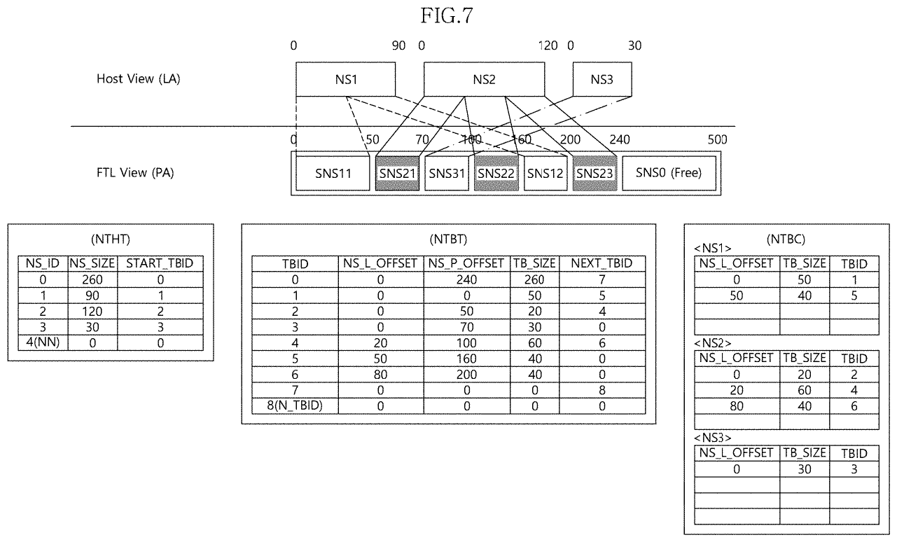

FIG. 7 is a diagram for explaining a name space management concept in accordance with an embodiment.

Referring to FIG. 7, a logical area LA addressable by the hose device may include name spaces NS1 to NS3. The name space 1 NS1 may correspond to a first sub-space SNS11 and a second sub-space SNS12 in a physical area PA addressable by the controller 110. The name space 2 NS2 may correspond to three sub-spaces SNS21 to SNS23, and the name space 3 NS3 may correspond to a single sub-space SNS31. A remaining physical area other than the sub-spaces SNS11 to SNS23 is a free area as a sub-space SNS0 corresponding to a name space 0 NS0.

The entry table NTHT may store the name space size NS_SIZE and the starting mapping table ID START_TBID for each name space.

In an embodiment, a first sub-space SNS11 with a size 50 and a second sub-space SNS12 with a size 40 are combined so that the name space 1 NS1 with a size 90 is configured. Referring to the entry table NTHT, it can be understood that the size of a name space having a NS_ID of 1 is 90 and the starting mapping table ID START_TBID is 1.

Referring to a position in which the mapping table ID TBID of the mapping table NTBT is 1, it can be understood that the logical address offset NS_L_OFFSET is 0, the physical address offset NS_P_OFFSET is 0, the sub-space size TB_SIZE is 50, and the following mapping table ID NEXT_TBID is 5. That is, the mapping table having an ID value of 1 includes mapping information on the first sub-space SNS11, which is a logical area of logical addresses 0 to 50 and a physical area of physical addresses 0 to 50 among sub-spaces included in the name space having an ID value of 1, and indicates that the following mapping table ID NEXT_TBID is 5. Furthermore, mapping information on following sub-spaces of the sub-spaces having the physical addresses 0 to 50 may be identified from a mapping table NTBT of the following mapping table ID NEXT_TBID having the value of 5.

The index cache NTBC may be constructed for each name space, and may have information for identifying the mapping table within the mapping table NTBT. In and embodiment, each index cache may be constructed by extracting and sorting information, which is required for accessing a physical area according to a request of the host device, of the information of the mapping table (NTBT).

In an embodiment, each index cache NTBC may have the information of the sub-space size TB_SIZE and the mapping table ID TBID of sub-spaces sorted by the logical address offset NS_L_OFFSET.

When a name space ID NS_ID and a logical address are provided from the host device, it is possible to access an index cache NTBC of the provided name space ID NS_ID and determine a mapping table ID TBID corresponding to the requested logical address based on the logical address offset NS_L_OFFSET and the sub-space size TB_SIZE, so that it is possible to access the determined mapping table ID TBID within the mapping table NTBT to find a physical address corresponding to the requested logical address and thus access a physical area of the found physical address within the storage 120.

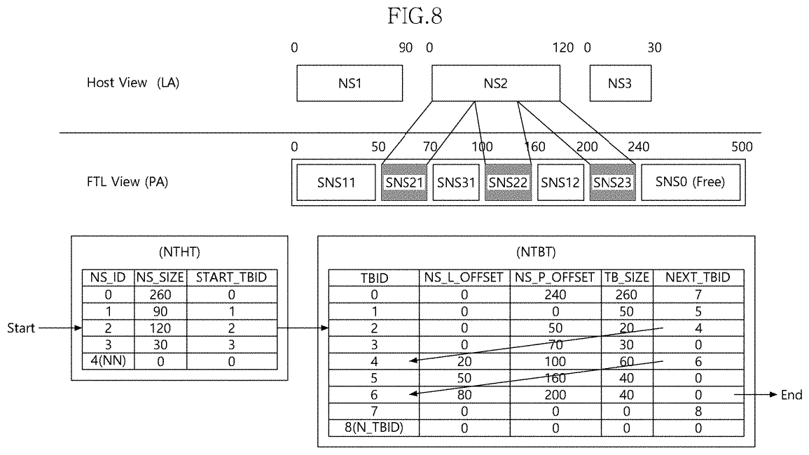

FIG. 8 is a diagram for explaining a name space mapping concept in accordance with an embodiment.

With reference to FIG. 8, a description will be provided for a concept for searching for mapping information on sub-spaces constituting the name space 2 NS2 through the entry table NTHT for the name space 2 NS2.

Referring to the entry table NTHT of the name space 2 NS2, it can be understood that the size of the name space 2 NS2 is 120 and the starting mapping table ID START_TBID is 2.

Referring to a position in which the mapping table ID TBID of the mapping table NTBT is 2, it can be understood that the logical address offset NS_L_OFFSET is 0, the physical address offset NS_P_OFFSET is 50, the sub-space size TB_SIZE is 20, and the following mapping table ID NEXT_TBID is 4. Accordingly, it can be understood that a logical area of the logical addresses 0 to 20 within the name space 2 NS2 corresponds to the first sub-space SNS21 having physical addresses 50 to 70.

Referring to information indicating that the mapping table ID TBID as the following mapping table ID NEXT_TBID is 4, it can be understood that the logical address offset NS_L_OFFSET is 20, the physical address offset NS_P_OFFSET is 100, the sub-space size TB_SIZE is 60, and the following mapping table ID NEXT_TBID is 6. Accordingly, it can be understood that a logical area of the logical addresses 20 to 80 within the name space 2 NS2 corresponds to the second sub-space SNS22 having physical addresses 100 to 160.

Referring to information indicating that the mapping table ID TBID as the following mapping table ID NEXT_TBID is 6, it can be understood that the logical address offset NS_L_OFFSET is 80, the physical address offset NS_P_OFFSET is 200, the sub-space size TB_SIZE is 40, and the following mapping table ID NEXT_TBID is 0. Accordingly, it can be understood that a logical area of the logical addresses 80 to 120 within the name space 2 NS2 corresponds to the third sub-space SNS23 having physical addresses 200 to 240.

A free physical area, which is not allocated to any name space, may be represented by the name space ID and the mapping table ID TBID both having a value of 0. The following mapping table ID NEXT_TBID having a value of 0 may represent that a corresponding mapping table or a corresponding sub-space has no following sub-space.

The name space 2 NS2 having logically continuous addresses 0 to 120 is mapped to a plurality of sub-spaces having the discontinuous physical addresses 50 to 70, 100 to 160, and 200 to 240 through the entry table NTHT and the mapping table NTBT.

For the name space 1 NS1 and the name space 3 N53, the logical-physical areas may be mapped and searched in substantially the same manner.

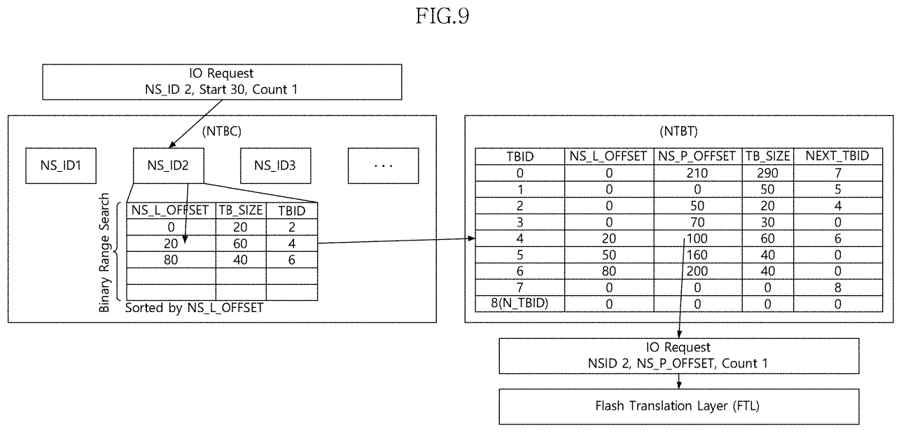

FIG. 9 is a diagram for explaining a name space search concept in accordance with an embodiment.

It is assumed that the host device requests access to a logical address 30 of the name space 2 NS2.

The name space manager 20 may access the index cache NTBC for the name space 2 NS2. Since the logical address range is the sub-space size TB_SIZE from the logical address offset NS_L_OFFSET, it can be understood that the logical address 30 is included in a logical area of the logical addresses 20 to 80. Since the mapping table ID TBID corresponding to such a logical area is 4, the name space manager 20 may access the mapping table having the mapping table ID TBID of 4 within the mapping table NTBT.

Since the logical addresses 20 to 80 are mapped to the physical addresses 100 to 160 within the mapping table having the mapping table ID TBID of 4, it can be understood that the logical address 30 is mapped to the physical address 110 due to the relationship between the logical and physical address ranges (i.e., the logical addresses 20 to 80 and the physical addresses 100 to 160), and the name space manager 20 may access the physical storage area of the physical address 110 within the storage 120.

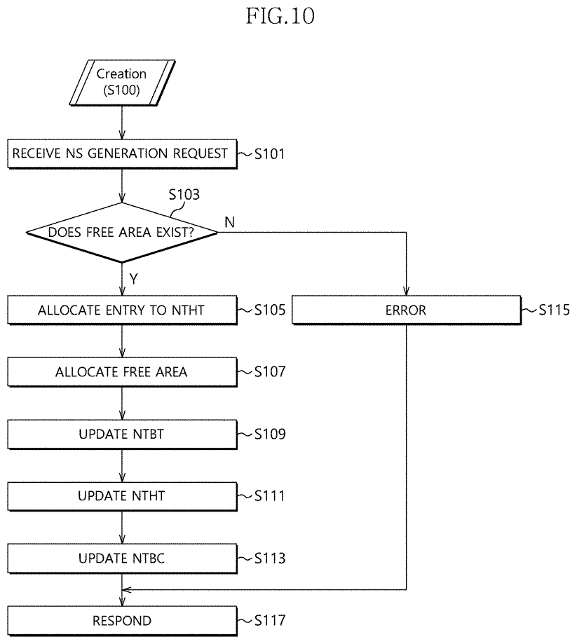

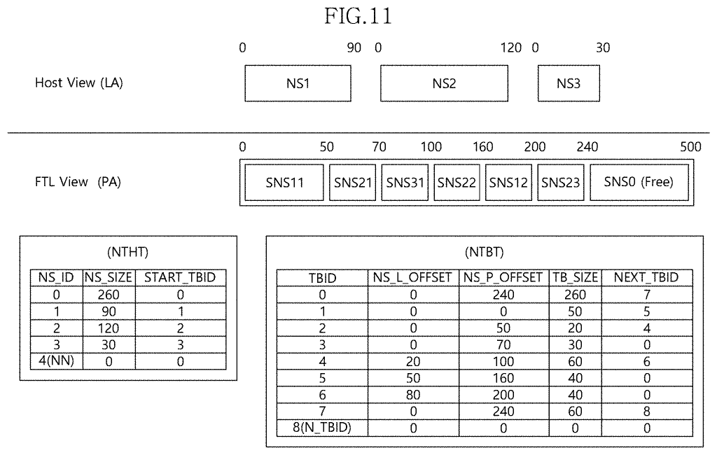

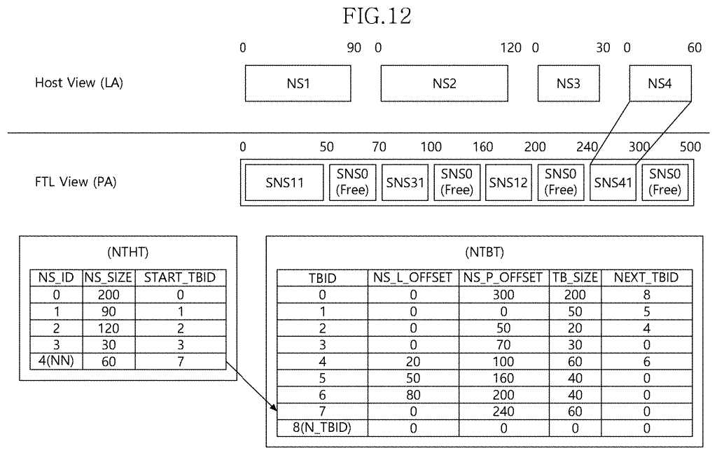

FIG. 10 is a flowchart for explaining a name space generation method in accordance with an embodiment, and FIG. 11 and FIG. 12 are conceptual diagrams for explaining a name space generation operation in accordance with an embodiment.

In response to a name space generation request of the host device, the name space generating device 210 of the name space manager 20 may select at least one sub-space having physically continuous or discontinuous addresses in the storage 120, allocate the selected sub-space to a name space, and update the address mapping information in the entry table NTHT, the mapping table NTBT and the index cache NTBC.

In another aspect, in response to the name space generation request of the host device, the name space generating device 210 may generate a name space by combining sub-spaces having physically discontinuous addresses with one another and a requested size.

With reference to FIG. 10 to FIG. 12, a name space generation step S100 will be described.

As the name space generation request is received from the host device at Step S101, the name space generating device 210 may check whether there is a free area in the storage 120 at Step S103.

In an embodiment, the name space generating device 210 may check information on the name space size NS_SIZE of meta data having a name space ID of a value 0 within the entry table NTHT, and may check whether there is a free area with a size equal to or more than a size requested to be generated by the host device.

When there is the free area for the requested name space with the requested size (“Y”) at Step S103, the name space generating device 210 may allocate a new entry of a name space to the entry table NTHT at step S105 and add a name space ID to the new entry of a name space. In an embodiment, the name space generating device 210 may add a new name space ID having an ID value of 4 as illustrated in FIG. 11.

Then, the name space generating device 210 may allocate a physical area, which has the requested size within the free area, to the new name space at Step S107. For example, FIG. 7 exemplifies the free area having a size of 260 with the physical addresses 240 to 500 (see “SNSO (Free)”). When the name space size NS_SIZE requested to be generated is 60, the name space generating device 210 may allocate a physical area which has a size 60 within the free area.

Referring to the mapping table NTBT of the free area in FIG. 7, the following mapping table ID NEXT_TBID is 7 and thus mapping information on the new name space may be added to a position in which the mapping table ID TBID is 7. As illustrated in FIG. 11, it can be understood that a physical area with the requested size 60 is newly allocated to a position, in which mapping table ID TBID is 7, to the name space from a position, in which the physical address offset NS_P_OFFSET is 240.

After the new name space is generated, the name space generating device 210 may update the mapping table NTBT at step S109. Referring to FIG. 12, since the new name space 4 NS4 has a logical addresses 0 to 60, it can be understood that the logical address offset NS_L_OFFSET, the physical address offset NS_P_OFFSET, and the sub-space size TB_SIZE are added to a position in which the mapping table ID TBID of the mapping table NTBT is 7. Furthermore, since the new name space 4 NS4 includes only a single sub-space, the following mapping table ID NEXT_TBID may be set to 0.

Furthermore, it can be understood that mapping information on a position of the mapping table ID TBID for the free area and having a value of 0 is updated by reducing the size of the free area by the size of the newly allocated name space, and the following mapping table ID NEXT_TBID is changed to 8.

Then, the name space generating device 210 may update to the entry table NTHT at step Sill. Referring to FIG. 12, it can be understood that size information 60 and the starting mapping table ID START_TBID having a value of 7 are updated for an entry of the new name space ID NS_ID having a value of 4.

Then, the name space generating device 210 may update the index cache NTBC at Step S113, thereby coping with an access request of the host device at a high speed.

Meanwhile, when there is no area for allocating a new name space (“N”) at Step S103, the name space generating device 210 may process the situation as an error at step S115.

After the name space is successfully generated or the error processing due to the free area insufficiency, the name space generating device 210 may transmit a processing result to the host device at Step S117.

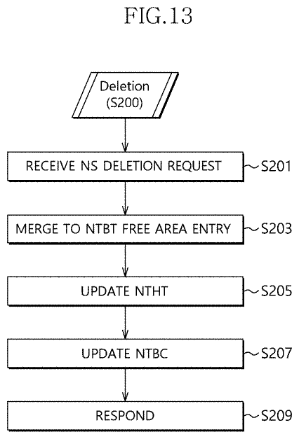

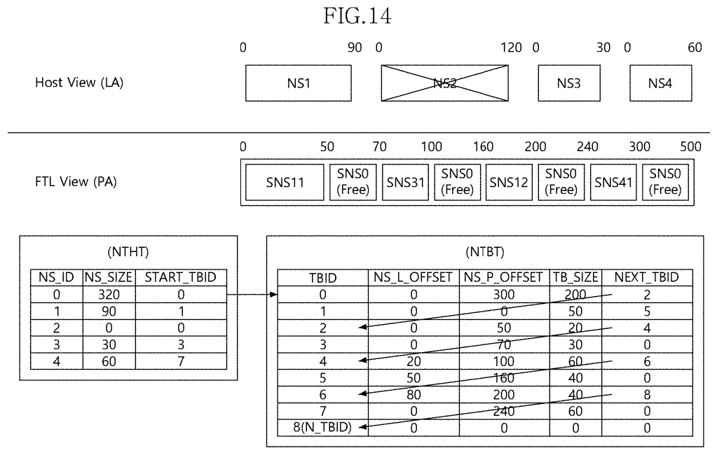

FIG. 13 is a flowchart for explaining a name space deletion method in accordance with an embodiment, and FIG. 14 is a conceptual diagram for explaining a name space deletion operation in accordance with an embodiment.

In an embodiment, in response to a name space deletion request of the host device, the name space manager 20 may free a sub-space, which is included in a name space requested to be deleted, and update the address mapping information.

With reference to FIG. 13 and FIG. 14, a name space deletion process 200 will be described.

In response to the name space deletion request of the host device at Step S201, the name space deletion device 220 may access the mapping table NTBT on the basis of a name space ID requested to be deleted and free the physical area of the name space requested to be deleted at Step S203).

In an embodiment, in the name space state illustrated in FIG. 7, when the name space 2 NS2 is requested to be deleted, the name space deletion device 220 may identify the starting mapping table ID START_TBID having a value of 2 from the entry table NTHT for the access to the name space 2 N52. Furthermore, as illustrated in FIG. 14, the name space deletion device 220 may change the following mapping table ID NEXT_TBID to have a value of 2 in the mapping information of the mapping table ID having a value of 0 for the free area. The mapping table ID having a value of 2 represents the starting sub-space of the delete-requested name space 2 NS2. Accordingly, the sub-space of the physical addresses 50 to 70, which represented by the mapping table ID having a value of 2, becomes a free area and the following sub-spaces of the physical addresses 100 to 160 and 200 to 240, which are represented by the mapping table IDs having values of 4 and 6, also become a free area.

Accordingly, when the sub-spaces of the physical addresses 50 to 70, 100 to 160 and 200 to 240 corresponding to the name space 2 NS2 requested to be deleted are returned to the free area, the name space deletion device 220 may update the entry table NTHT as illustrated in FIG. 14 at Step S205 and may also update the index cache NTBC at Step S207. When the deletion process is completed, the name space deletion device 220 may transmit the completion of the deletion to the host device at step S209.

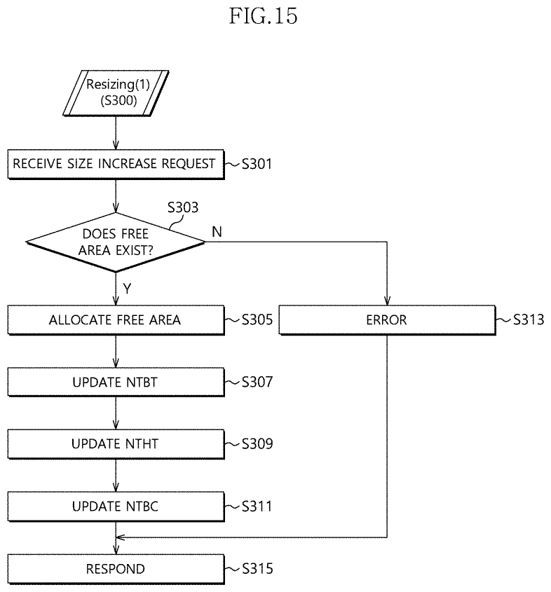

FIG. 15 is a flowchart for explaining a name space change method in accordance with an embodiment.

In an embodiment, in response to a name space size increase request of the host device, when there is a free area with a requested size or more, the name space manager 20 may select at least one physically continuous or discontinuous sub-space, additionally allocate the selected sub-space for an existing name space, and update the address mapping information in the entry table NTHT, the mapping table NTBT and the index cache NTBC.

FIG. 15 illustrates a flowchart for a name space size change, for example, a process at Step S300 of increasing a name space size.

In response to the name space size increase request of the host device at Step S301, the name space changing device 230 may determine whether there is a free area with a size equal to or more than a size requested to increase at Step S303.

In an embodiment, the name space changing device 230 may check information on the name space size NS_SIZE of meta data having a name space ID having a value of 0 within the entry table NTHT, and may check whether there is a free area with a size equal to or more than a size requested to increase by the host device.

When there is the free area with the requested size or more (“Y”) at Step S303, the name space changing device 230 may additionally allocate an area of the free area, which corresponds to the requested size, for the existing name space at Step S305.

After the additional physical area is allocated to an existing name space, the name space changing device 230 may update the mapping table NTBT, the entry table NTHT, and the index cache NTBC at steps S307, S309, and S311.

Meanwhile, when there is no area for increasing a name space (“N”) at step S303, the name space changing device 230 may process the situation as an error at Step S313.

After the name space is successfully increased or the error processing due to the free area insufficiency, the name space changing device 230 may transmit a processing result to the host device at Step S315.

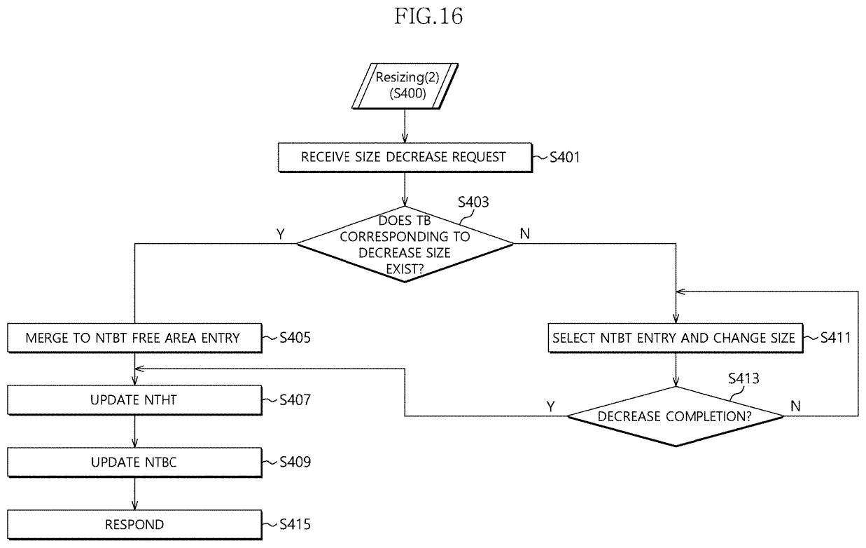

FIG. 16 is a flowchart for explaining a name space change method in accordance with an embodiment.

In an embodiment, in response to a name space size decrease request of the host device, the name space manager 20 may allocate a physical area with a requested size of a physical area of a name space requested to decrease to a free area, and update the address mapping information in the entry table NTHT, the mapping table NTBT and the index cache NTBC.

FIG. 16 illustrates a flowchart for a name space size change, for example, a process at step S400 of decreasing a name space size.

In response to the name space size decrease request of the host device at Step S401, the name space changing device 230 may check whether a sub-space corresponding to a size requested to decrease exists in sub-spaces constituting a name space requested to decrease at Step S403.

When there is the sub-space corresponding to the size requested to decrease (“Y”) at Step S403, the name space changing device 230 may access the mapping table NTBT on the basis of a name space ID NS_ID requested to decrease, and free the sub-space, which corresponds to the size requested to decrease of the physical area of the name space requested to decrease at Step S405. A process for freeing a sub-space with a size to decrease is similar to the aforementioned name space deletion process.

Accordingly, when a partial space of the name space requested to decrease is returned to the free area, the name space changing device 230 may update the entry table NTHT and the index cache NTBC at steps S407 and S409.

When there is no sub-space corresponding to the size requested to decrease (“N”) at Step S403, the name space changing device 230 may select any one of sub-spaces constituting the name space requested to decrease and change a size thereof at step S411. In an embodiment, the name space changing device 230 may select a sub-space approximate to the size requested to decrease, return a partial space of the selected sub-space to the free area, and then change the mapping table NTBT. Such a process may be performed until the size is decreased to the size requested to decrease (“N”) at step S413. Accordingly, when the size is decreased to the requested size requested (“Y”) at Step S413, the name space changing device 230 may update the entry table NTHT and the index cache NTBC at steps S407 and S409.

When the decrease process is completed, the name space changing device 230 may transmit the completion of the decrease process to the host device at step S415.

A sub-space may be fragmented again by the name space decrease procedure, but since fragmented physical areas may be collected to generate a name space logically serving as one area, the use efficiency of the storage 120 may not be reduced.

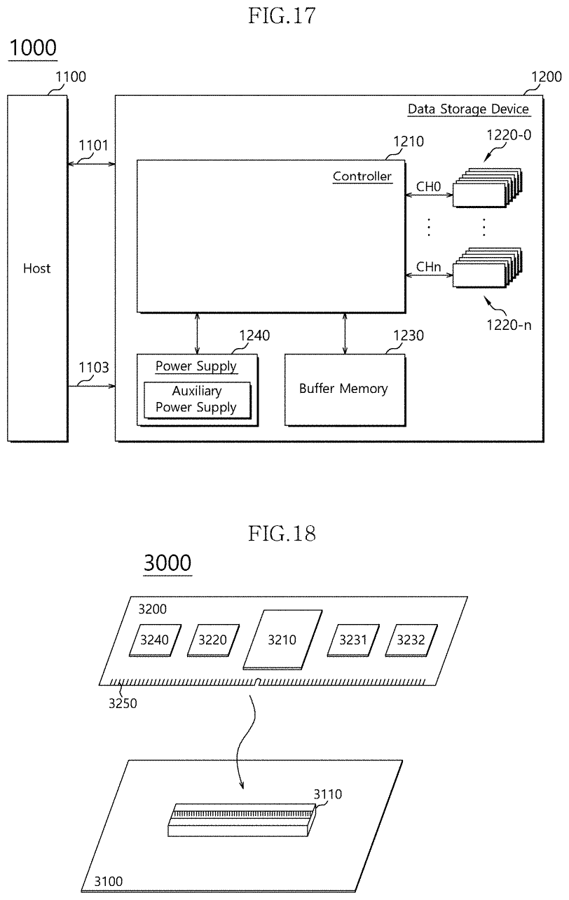

FIG. 17 is a diagram illustrating a data storage system in accordance with an embodiment.

Referring to FIG. 17, the data storage 1000 may include a host device 1100 and the data storage device 1200. In an embodiment, the data storage device 1200 may be configured to a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface unit, a control unit, a random access memory used as a working memory, an error correction code (ECC) unit, and a memory interface unit. In an embodiment, the controller 1210 may configured by controller 110 as shown is FIG. 1 to FIG. 3.

The host device 1100 may exchange a signal with the data storage device 1200 through the signal connector 1101. The signal may include a command, an address, data, and so forth.

The controller 1210 may analyze and process the signal received from the host device 1100. The controller 1210 may control operations of internal function blocks according to a firmware or a software for driving the data storage device 1200.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power inputted through the power connector 1103, to the inside of the data storage device 1200. The power supply 1240 may include an auxiliary power supply. The auxiliary power supply may supply power to allow the data storage device 1200 to be normally terminated when a sudden power-off occurs. The auxiliary power supply may include large capacity capacitors.

The signal connector 1101 may be configured by various types of connectors depending on an interface scheme between the host device 1100 and the data storage device 1200.

The power connector 1103 may be configured by various types of connectors depending on a power supply scheme of the host device 1100.

FIG. 18 is a diagram illustrating a data processing system in accordance with an embodiment. Referring to FIG. 18, the data processing system 3000 may include a host device 3100 and the memory system 3200.

The host device 3100 may be configured in the form of a board such as a printed circuit board. Although not shown, the host device 3100 may include internal function blocks for performing the function of a host device.

The host device 3100 may include a connection terminal 3110 such as a socket, a slot or a connector. The memory system 3200 may be mounted to the connection terminal 3110.

The memory system 3200 may be configured in the form of a board such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 as shown in FIGS. 1 to 3,

The buffer memory device 3220 may temporarily store data to be stored in the nonvolatile memory devices 3231 and 3232. Further, the buffer memory device 3220 may temporarily store the data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250, to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data and so forth and power may be transferred between the host device 3100 and the memory system 3200. The connection terminal 3250 may be configured into various types depending on an interface scheme between the host device 3100 and the memory system 3200. The connection terminal 3250 may be disposed on any one side of the memory system 3200.

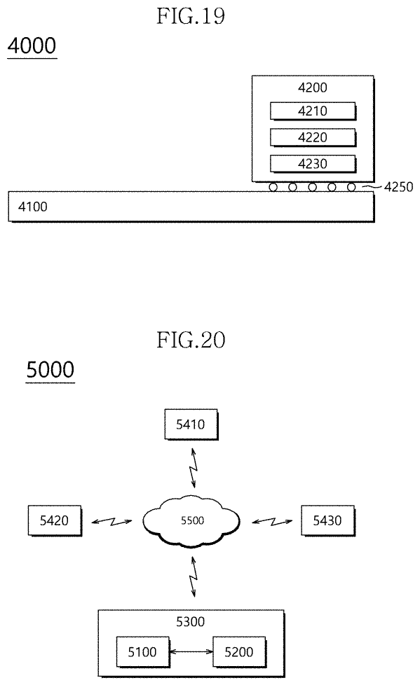

FIG. 19 is a diagram illustrating a data processing system in accordance with an embodiment. Referring to FIG. 19, the data processing system 4000 may include a host device 4100 and the memory system 4200.

The host device 4100 may be configured in the form of a board such as a printed circuit board. Although not shown, the host device 4100 may include internal function blocks for performing the function of a host device.

The memory system 4200 may be configured in the form of a surface-mounting type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 as shown in FIGS. 1 to 3.

The buffer memory device 4220 may temporarily store data to be stored in the nonvolatile memory device 4230. Further, the buffer memory device 4220 may temporarily store the data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

FIG. 20 is a diagram illustrating a network system including a data storage device in accordance with an embodiment. Referring to FIG. 20, the network system 5000 may include a server system 5300 and a plurality of client systems 5410 to 5430 which are coupled through a network 5500.

The server system 5300 may service data in response to requests from the plurality of client systems 5410 to 5430. For example, the server system 5300 may store the data provided from the plurality of client systems 5410 to 5430. For another example, the server system 5300 may provide data to the plurality of client systems 5410 to 5430.

The server system 5300 may include a host device 5100 and the memory system 5200. The memory system 5200 may be configured by the memory system 10 shown in FIG. 1, the data storage device 1200 shown in FIG. 17, the memory system 3200 shown in FIG. 18 or the memory system 4200 shown in FIG. 19.

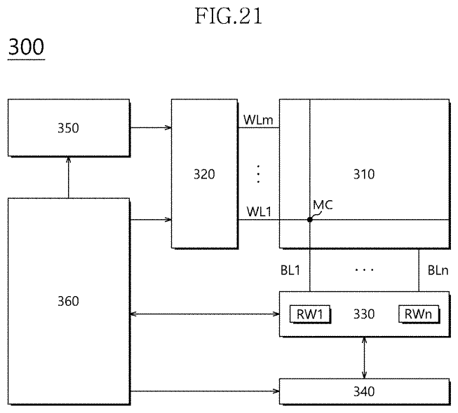

FIG. 21 is a block diagram illustrating a nonvolatile memory device included in a data storage device in accordance with an embodiment. Referring to FIG. 21, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array has a direction perpendicular to the flat surface of a semiconductor substrate. Moreover, the three-dimensional memory array means a structure including NAND strings which at least memory cell is located in a vertical upper portion of the other memory cell.

The structure of the three-dimensional memory array is not limited thereto. It is apparent that the memory array structure can be selectively applied to a memory array structure formed in a highly integrated manner with horizontal directionality as well as vertical directionality.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300. While various embodiments have been described above, it will be understood to those skilled in the art that the embodiments described are examples only. Accordingly, the data storage device, the operating method thereof and the storage system including the same described herein should not be limited based on the described embodiments.

While various embodiments have been described above, it will be understood to those skilled in the art that the embodiments described are examples only. Accordingly, the data storage device, the operation method thereof, and the storage system including the same described herein should not be limited based on the described embodiments.

What is claimed is:

1. A data storage device comprising:
a storage; and
a controller configured to:
control data exchange with the storage in response to a request of a host device;
generate a name space, which is a logical area and includes one or more sub-spaces each serving as a physical area of the storage, in response to the request of the host device; and
manage mapping information between the name space and the sub-spaces,
wherein each sub-space constituting the name space is selected to have a physically continuous or discontinuous address.

2. The data storage device according to claim 1, wherein the controller is further configured to:
generate and manage a mapping table for the one or more sub-spaces included in the name space; and
generate and manage address link information between the one or more sub-spaces included in the name space.

3. The data storage device according to claim 1, wherein the controller is further configured to:
generate meta information including a name space size and a starting mapping table ID for the name space; and
manage the meta information in the form of an entry table.

4. The data storage device according to claim 3, wherein the controller is further configured to:
assign the mapping table ID to each sub-space;
generate a logical address offset, a physical address offset, a sub-space size, and a following mapping table ID for each mapping table ID; and
manage the logical address offset, the physical address offset, the sub-space size, and the following mapping table ID in the form of a mapping table.

5. The data storage device according to claim 4, wherein the controller is further configured to generate and manage an index cache having information of the mapping table and the logical address offset for each name space.

6. The data storage device according to claim 1, wherein the controller is further configured to:
generate, when a free area with a requested generation size or more exists in the storage, a name space by combining sub-spaces having physically discontinuous addresses with each other and having the requested generation size, in response to a name space generation request of the host device; and
update the mapping information based on the generation of the name space.

7. The data storage device according to claim 1, wherein the controller is further configured to:
release a sub-space included in a name space requested to be deleted to a free area in response to a name space deletion request of the host device; and
update the mapping information based on the deletion of the name space.

8. The data storage device according to claim 1, wherein the controller is further configured, in response to a name space size increase request of the host device, to:
select, when a free area with a requested increase size or more exists, at least one sub-space, which is physically continuous or discontinuous;
additionally allocate the selected at least one sub-space for an existing name space; and
update the mapping information based on the additional allocation.

9. The data storage device according to claim 1, wherein the controller is further configured to:
release, in response to a name space size decrease request of the host device, a physical area with a requested size from a name space requested to decrease; and
update the mapping information based on the release.

10. An operation method of a data storage device including a storage and a controller configured to control data exchange with the storage, the method comprising:
generating, by the controller, a name space, which is a logical area and includes one or more sub-spaces each serving as a physical area of the storage, in response to a request of the host device; and
updating, by the controller, mapping information between the name space and the sub-spaces,
wherein each sub-space constituting the name space is selected to have a physically continuous or discontinuous address.

11. The operation method according to claim 10, wherein the step of updating the mapping information comprises:
generating, by the controller, a mapping table for each sub-space included in the name space; and
generating and managing address link information between the one or more sub-spaces included in the name space.

12. The operation method according to claim 10, wherein the step of updating the mapping information comprises:
generating, by the controller, meta information including a name space size and a starting mapping table ID for the name space; and
managing the meta information in the form of an entry table.

13. The operation method according to claim 12, wherein the step of updating the mapping information comprises:
assigning, by the controller, the mapping table ID to each sub-space;
generating a logical address offset, a physical address offset, a sub-space size, and a following mapping table ID for each mapping table ID; and
managing the logical address offset, the physical address offset, the sub-space size, and the following mapping table ID in the form of a mapping table.

14. The operation method according to claim 13, wherein the step of updating the mapping information comprises generating and managing an index cache having information of the mapping table and the logical address offset for each name space.

15. The operation method according to claim 10, further comprising, in response to a name space generation request of the host device:
checking, by the controller, whether a free area with a requested generation size or more exists in the storage;
generating, by the controller, a name space by combining sub-spaces having physically discontinuous addresses with each other and having the requested generation size when the free area exists; and
updating, by the controller, the mapping information based on the generation of the name space.

16. The operation method according to claim 10, further comprising:
releasing, by the controller, a sub-space included in a name space requested to be deleted to a free area in response to a name space deletion request of the host device; and
updating, by the controller, the mapping information based on the deletion of the name space.

17. The operation method according to claim 10, further comprising, in response to a name space size increase request of the host device, the steps of:
checking, by the controller, whether a free area with a requested increase size or more exists;
selecting, by the controller, at least one sub-space, which is physically continuous or discontinuous;
additionally allocating the selected at least one sub-space for an existing name space when the free area exists; and
updating the mapping information based on the additional allocation.

18. The operation method according to claim 10, further comprising steps of:
releasing, in response to a name space size decrease request of the host device, a physical area with a requested size from a name space requested to decrease; and
updating the mapping information based on the release.

19. A memory system comprising:
a memory device including a plurality of storage segments each represented by a physical address; and
a controller configured to:
assign one or more among the storage segments for a name space addressable by an external device;
release one or more among the storage segments assigned for the name space;
update relationship between one or more among the assigned and released storage segments and the name space within first and second tables; and
control, through the first and second tables, access to the assigned storage segments in response to an access request provided along with a logical address of the name space from the external device.

20. The memory system according to claim 19, wherein the first table includes an entry of the name space having fields of a size and a starting storage segment thereof, and
wherein the second table includes an entry of the assigned or released segment having fields of logical and physical address offsets, a size and a following storage segment thereof.
